(19) United States
(12) Patent Application Publication
(10) Pub. No.: US 2012/0136729 A1
(43) Pub. Date: May 31, 2012

(54) METHOD AND SYSTEM FOR SNIPPET-MODIFIED TELEVISION ADVERTISING

(75) Inventor: Srilal Weerasinghe, Austin, TX (US)

(73) Assignee: AT&T INTELLECTUAL PROPERTY I, L.P., Reno, NV (US)

(21) Appl. No.: 12/957,069

(22) Filed: Nov. 30, 2010

(51) Int. Cl. G06Q 30/00; H04N 5/93; H04N 7/10

(52) U.S. Cl. 705/14.72; 725/32; 386/278

(57) ABSTRACT

A method and system for modifying original television ads to generate snippet-modified ads utilizes a snippet ad engine to automatically incorporate the snippet ad. A snippet ad may include content from the television program being interrupted by the original ad. The snippet ad engine may receive descriptor files for the original ad and the snippet ad, including parameters describing when and how the snippet ad is to be incorporated. The snippet ad engine may use digital video editing techniques to generate the snippet-modified ad, which may be output to an ad inserter/splicer for insertion into a digital television data stream.

### FIELD OF THE DISCLOSURE

The present disclosure relates to television advertising and, more particularly, to modification of multimedia content in television advertising.

### BACKGROUND

Subscribers to a multimedia content distribution network (MCDN) may be provided with a large number of television programs to choose from. A television program provided by the MCDN may include advertisements (ads) that interrupt the program. Advertisement interruptions may reduce viewer interest in both the ads and the program.

### BRIEF DESCRIPTION OF THE DRAWINGS

FIG. 1 is a block diagram of selected elements of an embodiment of an MCDN including a snippet ad engine;

FIG. 2 is a block diagram of selected elements of an embodiment of an MCDN including a snippet ad engine showing additional detail for the MCDN clients;

FIG. 3 is a block diagram of selected elements of an embodiment of an ad modification system;

FIG. 4 illustrates selected elements of an embodiment of an ad modification method;

FIG. 5 illustrates selected elements of an embodiment of an ad modification method;

FIG. 6 illustrates selected elements of an embodiment of an ad modification method;

FIG. 7 is a block diagram of selected elements of an embodiment of an application server; and

FIG. 8 illustrates selected elements of an embodiment of a snippet-modified ad.

### DESCRIPTION OF EMBODIMENTS

In one aspect, a disclosed method for modifying an original ad delivered via digital television includes accessing an original ad descriptor file associated with the original ad and accessing a snippet ad descriptor file associated with a snippet ad. The original ad descriptor file may include parameters describing criteria for using the snippet ad with the original ad, while the snippet ad descriptor file may include parameters describing aspects of the snippet ad. Based on the descriptor file parameters, the original ad may be modified by including some or all of the snippet ad to generate a snippet-modified ad, and inserting the snippet-modified ad within a digital television program. The original and descriptor file parameters may define a display location of the snippet ad within the original ad, a display size of the snippet ad, a modification to the snippet ad, a desired duration of the snippet ad, a content specifier for the snippet ad, or a combination thereof. The snippet ad descriptor file parameters may include or define a snippet ad identifier, a duration of the snippet ad, a format of the snippet ad, a content specifier, a usage description for the snippet ad, or a combination thereof. The display size of the snippet ad may be a full display size of the original ad.

In certain embodiments, when at least one of the descriptor file parameters prohibit modification of the original ad, the method may include outputting the original ad for insertion within the digital television program. The snippet ad may include a video clip and/or a still image. The snippet ad may be an item of multimedia content such as a previously displayed portion of the digital television program, an upcoming portion of the digital television program, a rendering of the digital television program, or other content associated. The snippet ad may represent an ad including business information and/or an ad including product information.

In another aspect, a disclosed computing device for generating snippet-modified ads in an MCDN includes a processor coupled to memory media. The memory media may include processor executable instructions to access an original ad intended for an MCDN program, access an original ad descriptor file specifying usage of a snippet ad with the original ad, access the snippet ad, and access a snippet ad descriptor file specifying features of the snippet ad. The memory media may further include processor executable instructions to determine a snippet modification of the original ad based on the original ad descriptor file and the snippet ad descriptor file, and perform the snippet modification of the original ad. At least a portion of the snippet ad may be incorporated into the original ad to create a snippet-modified ad.

In some embodiments, the instructions may include instructions to output the snippet-modified ad to an ad splicer for insertion into the MCDN program. The snippet ad may include one or more video clips and/or one or more still images. Performing the snippet modification may include modifying the original ad using digital video editing to incorporate the snippet ad. The snippet-modified ad may include audio content associated with the original ad. The original ad descriptor file may include a display location of the snippet ad within the original ad, a display size of the snippet ad, a modification to the snippet ad, a duration of the snippet ad, content category restrictions for the snippet ad, or other display ad parameters. The snippet ad descriptor file may include or define an identifier for the snippet ad, a duration of the snippet ad, a format of the snippet ad, a content category for the snippet ad, usage limitations for the snippet ad, or other snippet ad parameters. Determining the snippet modification may include comparing the content category for the snippet ad with the content category restrictions for the snippet ad.

In another aspect, a disclosed computer-readable memory media includes executable instructions for generating snippet-modified ads in an MCDN. The instructions may access an original ad intended for an MCDN program and an associated original ad descriptor file specifying usage of a snippet ad with the original ad. The instructions may also access the snippet ad and an associated snippet ad descriptor file specifying features of the snippet ad, compare the original ad descriptor file with the snippet ad descriptor file to determine a snippet modification of the original ad, and perform the snippet modification of the original ad. At least a portion of the snippet ad may be incorporated into the original ad to create a snippet-modified ad. The snippet-modified ad may be inserted into the MCDN program. The original ad descriptor file may include a display location of the snippet ad within the original ad, a display size of the snippet ad, a modification to the snippet ad, a desired duration of the snippet ad, a desired content for the snippet ad, other display ad parameters, or a combination thereof. The snippet ad descriptor file may include an identifier for the snippet ad, a duration of the snippet ad, a format of the snippet ad, content included in the snippet ad, usage rules for the snippet ad, other snippet ad parameters, or a combination thereof.

In some embodiments, performing the snippet modification may include generating the snippet ad based on at least one parameter included in the original ad descriptor file. The snippet ad may include a video clip and/or a still image. The snippet ad may be an item of multimedia content such as a previously displayed portion of the MCDN program, an upcoming portion of the MCDN program, a rendering of the MCDN program, other content associated with the MCDN program, or a combination thereof. The snippet ad may represent an ad including business information and/or an ad including product information. Accessing the snippet ad may include receiving the snippet ad from a data stream providing the MCDN program, a data stream providing a different MCDN program, a network location, a third-party provider, extraction from MCDN multimedia content, or a combination thereof.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

As used herein, an “original ad” refers to multimedia content of an advertisement in an unmodified or original form, for example, as received from an advertisement provider by a network service provider for distribution. The terms “ad” and “advertisement” shall be used interchangeably herein. The terms “snippet” or “snippet ad,” as used herein, refer to multimedia content that is integrated into an original ad, for example, using digital video editing techniques. An exemplary type of snippet ad includes content from a television program that is interrupted by the original ad. Other types of snippet ads may also be used, as will be described in further detail herein. After the original ad has been modified to integrate the snippet ad, the resulting ad is referred to herein as a “snippet-modified ad.”

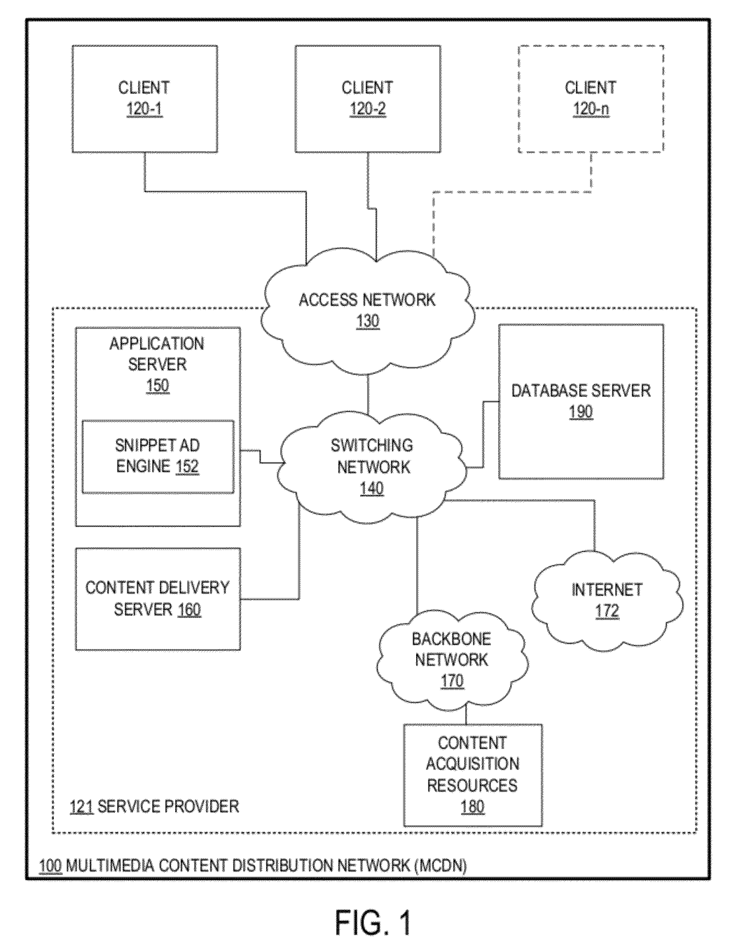

Turning now to the drawings, FIG. 1 is a block diagram illustrating selected elements of an embodiment of an MCDN 100, including a snippet ad engine 152, which may be used for presenting snippet-modified ads to users of MCDN 100, as will be described in detail herein. Although multimedia content is not limited to television (TV), video-on-demand (VOD), or pay-per-view (PPV) programs, the depicted embodiments of MCDN 100 and its capabilities are primarily described herein with reference to these types of multimedia content, which are interchangeably referred to herein as “multimedia content”, “multimedia content programs”, “multimedia programs”, “television programs”, “MCDN programs”, “digital television programs” or, simply, “programs.”

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Service provider 121 may include, as examples, content acquisition resources 180 connected to switching network 140 via backbone network 170, an application server 150, a database server 190, and a content delivery server 160, also shown connected to switching network 140.

Access network 130 demarcates clients 120 and service provider 121, and provides at least one connection path between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third party may own and/or operate at least a portion of access network 130.

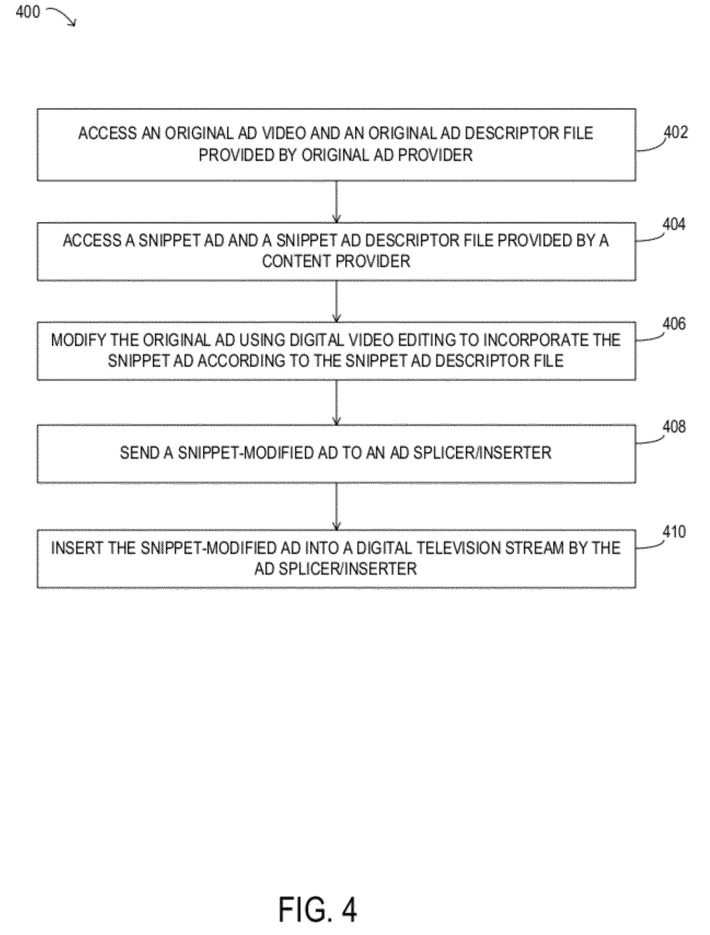

In some embodiments of access network 130 including some IP-compliant embodiments of access network 130, access network 130 may include a physical layer of unshielded twisted pair cables, fiber optic cables, or a combination of both. MCDN 100 may include digital connections between clients 120 and a node (see also FIG. 4) in access network 130 while fiber, cable or another broadband medium connects service provider resources to the node. In other embodiments, the broadband cable may extend all the way to clients 120. In certain embodiments, fiber optic cables may be provided from the node in access network 130 to each individual client 120. The connections between access network 130 and clients 120 may include digital subscriber line (DSL) connections. In particular embodiments, the connections may be DSL-compliant twisted pair or another type of galvanic loop (see also FIG. 4).

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL-compliant connections, switching network 140 and/or access network 130 may include elements of a DSL access multiplexer (DSLAM) that multiplexes many subscriber DSLs to backbone network 170 (see also FIG. 4).

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

Thus, the content provided by service provider 121 encompasses multimedia content that is scheduled in advance for viewing by clients 120 via access network 130. Such multimedia content, also referred to herein as “scheduled programming,” may be selected using an electronic programming guide (EPG). Accordingly, a user of MCDN 100 may be able to browse scheduled programming well in advance of the broadcast date and time. Some scheduled programming may be “regularly” scheduled programs, which recur at regular intervals or at the same periodic date and time (i.e., daily, weekly, monthly, etc.). Programs which are broadcast with little or no notice or which interrupt scheduled programs are referred to herein as “unscheduled programming.”

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140. Content delivered by MCDN 100 may also include advertisements, which may be provided by an ad provider or other third-party source, and as will be described in further detail, which may be modified by snippet ad engine 152 to generate snippet-modified ads.

Although service provider 121 is depicted in FIG. 1 as encompassing switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPGs, DVR services, VOD programs, PPV programs, Internet protocol television (IPTV) portals, digital rights management (DRM) servers, navigation/middleware servers, conditional access systems (CAS), and remote diagnostics, as examples.

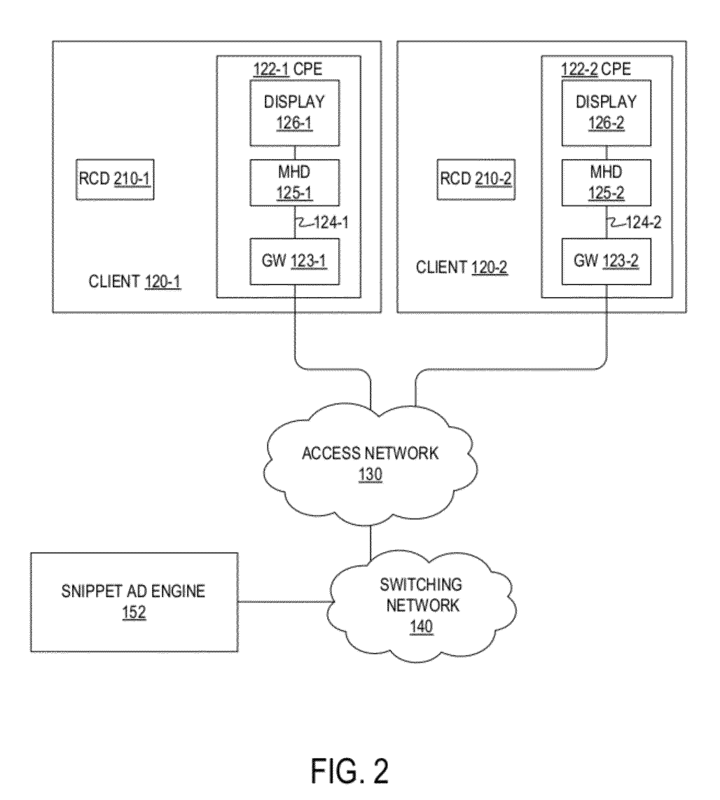

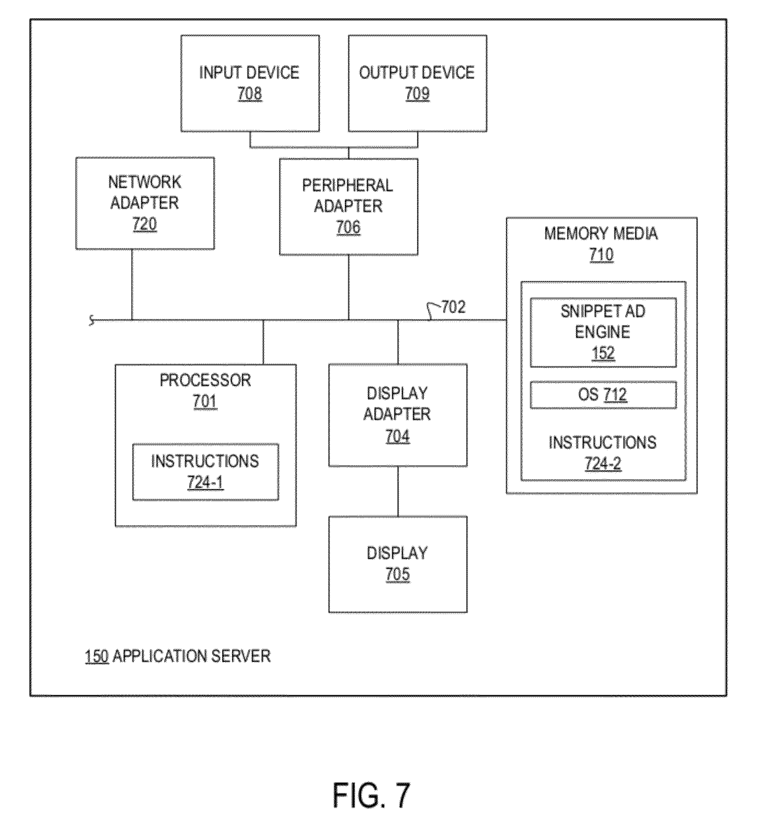

Applications provided by application server 150 may be downloaded and hosted on other network resources including, for example, content delivery server 160, switching network 140, and/or on clients 120. Application server 150 is configured with a processor and storage media (see also FIG. 7) and is enabled to execute processor executable instructions, such as those included within a software application. As depicted in FIG. 1, application server 150 may be configured to include various applications, such as snippet ad engine 152 (see also FIG. 2, 3, 7) for generating snippet-modified ads, that may provide functionality to clients 120.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as program or channel metadata for clients 120. Database server 190 may also store device information, such as identifiers for client 120, model identifiers for remote control devices, and identifiers for peripheral devices, etc.

Internet 172 as depicted in FIG. 1 is representative of any public network accessible via switching network 130. Access to Internet 172 may encompass publication of websites, web pages, and web applications that may be invoked using a universal resource locator (URL), such as an Internet web address. A web browser or similar application may be used to access a published website using an Internet user device (not shown in FIG. 1). In certain implementations, application server 150 and/or database server 190 may be configured to host web servers (not shown in FIG. 1) accessible via Internet 172, whereby the web servers provide functionality for publishing websites and managing various URLs related thereto. It is noted that websites published using MCDN 100 may provide controlled access based on an MCDN client account associated with individual client 120. Client-specific websites may thus enable client-specific information and/or communication channels to be made available by MCDN 100 via Internet 172.

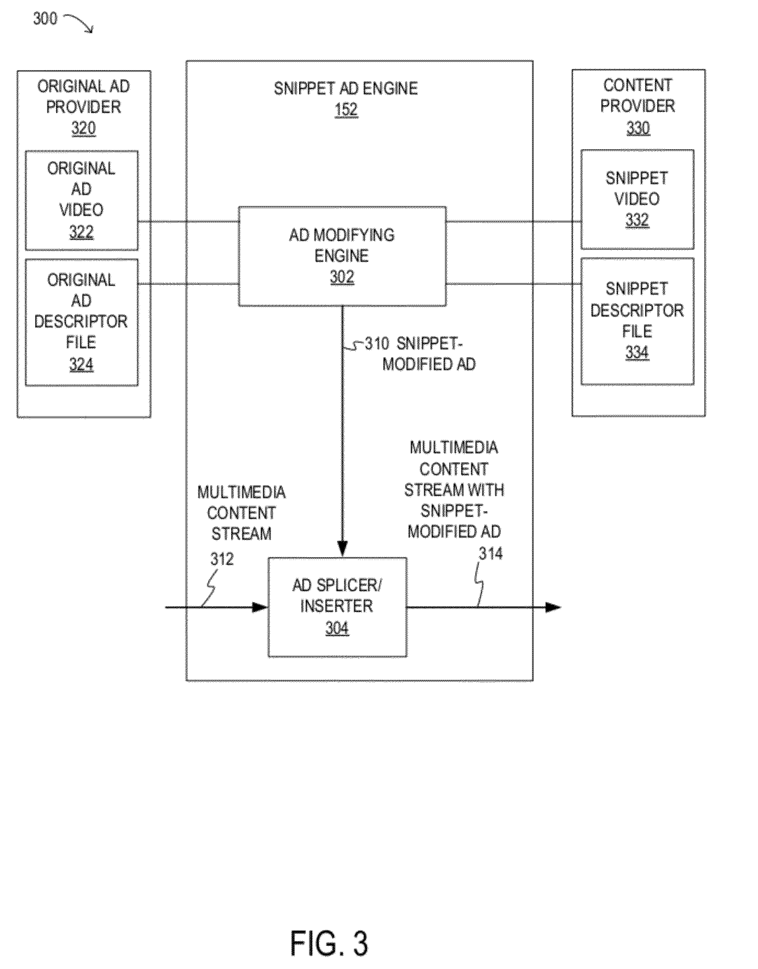

Also shown in FIG. 1 is snippet ad engine 152, which, in certain embodiments, may provide functionality to generate snippet-modified ads, as will be explained in further detail herein. It is noted that snippet ad engine 152 may represent a service provided by application server 150 to users of MCDN 100, to advertising clients of service provider 121, to content providers, and/or other entities. Snippet ad engine 152 (see also FIG. 2, 3, 7) may be configured to receive original ads and snippet ads and automatically generate snippet-modified ads based on parameters provided in various descriptor files. Snippet ad engine 152 may then insert the snippet-modified ads into a multimedia content stream for delivery to clients 120 (see also FIG. 3).

Turning now to FIG. 2, selected elements of clients 120 are shown in additional detail with respect to access network 130, switching network 140, and novel snippet ad engine 152. Clients 120 may include network appliances collectively referred to herein as customer premises equipment (CPE) 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device. It is noted that FIG. 2, as shown, includes remote control device (RCD) 210, snippet ad engine 152, and MHD 125, which, as discussed below, may implement modification of ad content provided by MCDN 100, including content from external sources, such as Internet 172 (see FIG. 1). MHD 125 may further be configured to output snippet-modified ad content according to the methods described herein.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination of both. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard for computer monitors and/or television displays. Standards for computer monitors include analog standards such as video graphics array (VGA), extended graphics array (XGA), etc., or digital standards such as digital visual interface (DVI) and high definition multimedia interface (HDMI), among others. A television display may comply with standards such as National Television System Committee (NTSC), Phase Alternating Line (PAL), or another suitable standard. Display 126 may include one or more integrated speakers to play audio content.

MHD 125 is enabled and configured to process incoming multimedia signals to produce audio and visual signals suitable for delivery to display 126 and any optional external speakers (not depicted in FIG. 2). Incoming multimedia signals received by MHD 125 may be compressed and/or encrypted, digital or analog, packetized for delivery over packet-switched embodiments of access network 130 or modulated for delivery over cable-based access networks. In some embodiments, MHD 125 may be implemented as a stand-alone set top box suitable for use in a co-axial or IP-based MCDN.

MHD 125 may be operable to send or receive requests or commands wirelessly to or from RCD 210, which may employ infrared (IR) or radio frequency (RF) signals. It is noted that MHDs 125 may also receive requests or commands via buttons (not depicted) located on side panels of MHDs 125. For example, a local transceiver may provide a direct communication link between MHD 125 and RCD 210. MHD 125 may be a functional component of CPE 122 along with GW 123 and display 126, independent of any physical implementation. In particular, it is noted that CPE 122 may be any combination of GW 123, MHD 125 and display 126. MHD 125 may include a processor coupled to storage media (not shown in FIG. 2). MHD 125 may further include a network adapter that interfaces MHD 125 to LAN 124 and through which MHD 125 receives multimedia content from access network 130, including snippet-modified ads provided by snippet ad engine 152. GW 123 is shown providing a bridge between access network 130 and LAN 124, and is configured to receive multimedia content (not shown) from access network 130. The storage media included in MHD 125 may be memory media (not shown) that encompasses persistent and volatile media, fixed and removable media, and magnetic and semiconductor media, and may be operable to store instructions, data, or both. The memory media included in MHD 125 may include sets or sequences of instructions and/or data, namely, an operating system and an EPG (not shown in FIG. 2). The operating system (not shown) may be a UNIX or UNIX-like operating system, a Windows® family operating system, or another suitable operating system. In some embodiments, the memory media (not shown) is configured to store and execute instructions provided as services to client 120 by application server 150, as mentioned previously.

The EPG may represent a guide to the multimedia content provided to client 120 via MCDN 100, and may be shown to the user as an element of an MHD user interface (not shown in FIG. 2) on display 126. The MHD user interface may include a plurality of menu items arranged according to one or more menu layouts, which enable a user to operate MHD 125. The user may operate the MHD user interface, including the EPG, using RCD 210.

Turning now to FIG. 3, a block diagram of selected elements of an embodiment of novel ad modification system 300 is depicted. It is noted that elements in FIG. 3 represent like-numbered elements discussed above with respect to FIGS. 1 and 2. Ad modification system 300 may employ an exemplary architecture for operation in conjunction with MCDN 100 (see FIG. 1), as described herein. In various embodiments, certain elements in ad modification system 300 may be omitted or rearranged, as desired.

In FIG. 3, ad modification system 300 is shown including certain elements of an exemplary embodiment of snippet ad engine 152, which is shown in further detail. Specifically, snippet ad engine 152 may include ad modifying engine 302 and ad splicer/inserter 304. It is noted that in certain embodiments, ad splicer/inserter 304 may be external to snippet ad engine 152. Also shown in ad modification system 300 are original ad provider 320 and content provider 330, which may provide ad content and descriptor files to ad modifying engine 302. Original ad provider 320 may be a separate entity from service provider 121 (see FIG. 1) and may deliver original ad video 322 and original ad descriptor file 324 to snippet ad engine 152 for processing by ad modifying engine 302. Content provider 330 may represent an entity that is external to service provider 121 or included in content acquisition resources 180 (see FIG. 1). In certain embodiments, content provider 330 may represent functionality that is at least in part included in snippet ad engine 152. As shown, content provider 330 may provide snippet video 332 and snippet descriptor file 334 to snippet ad engine 152 for processing by ad modifying engine 302. It is noted that the content included in snippet video 332 may include still images.

In operation of ad modification system 300, original ad provider 320 may provide original ad video 322 for insertion into an MCDN program for viewing by users of MCDN 100 at client 120 (see FIG. 1). In FIG. 3, multimedia content stream 312 may include the MCDN program. Original ad provider 320 may further provide original ad descriptor file 324, which may describe features or properties of original ad video 322, including aspects related to snippet modification. For example, original ad descriptor file 324 may specify or include parameters that specify: a display location of the snippet ad within the original ad, a display size of the snippet ad, a modification to the snippet ad, a desired duration of the snippet ad, a content specifier for the snippet ad, other parameters related to the original ad, or various combinations thereof. In this manner, ad modifying engine 302 may be provided original ad video 322 along with instructions, or specifications, describing how and when original ad video 322 may be modified to include a snippet. In certain instances, original ad descriptor file 324 may include information indicating that modification of original ad video 322 is not desired or is prohibited.

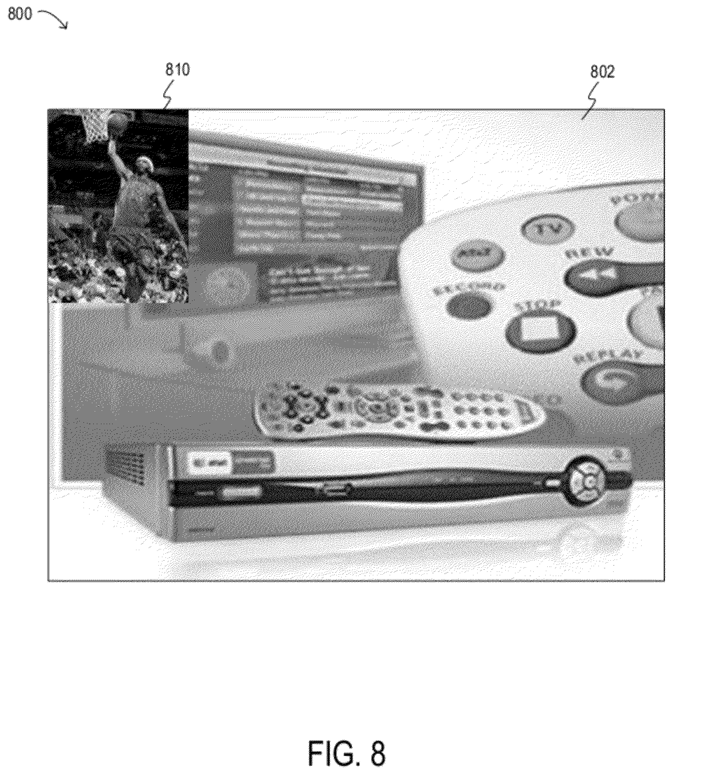

In ad modification system 300 as depicted in FIG. 3, content provider 330 may provide snippet video 332, which represents a snippet ad for integration within original ad video 322. Snippet video 332 may itself represent a portion of multimedia content stream 312 or the MCDN program represented therein. In certain instances, snippet video 332 may be a modified version of the MCDN program, such as a rendering of content or characters that appear in the MCDN program. Further examples of the content and form of snippet video 332 are described in detail with respect to FIG. 8 below. Along with snippet video 332, content provider 330 may deliver snippet descriptor file 334, which may describe features or properties of snippet video 332. For example, snippet descriptor file 334 may specify or include parameters that specify: an identifier for the snippet ad, a duration of the snippet ad, a format of the snippet ad, content included in the snippet ad, usage rules for the snippet ad, usage limitations for the snippet ad, other parameters related to the snippet ad, or various combinations thereof. Snippet ad engine 152 may then compare certain parameters in original ad descriptor file 324 with corresponding parameters in snippet descriptor file 334 to determine when and how original ad video 322 should be modified with snippet video 332. In certain embodiments, original ad descriptor file 324 may represent conditional parameters that govern when and how snippet video 332 may be included in original ad video 322, based on a match with parameters in snippet descriptor file 334. It is noted that original ad descriptor file 324 and snippet descriptor file 334 may be delivered in various formats, including, but not limited to, text, HTML, XML, or combinations thereof. In certain embodiments, snippet ad engine 152 may include additional processing resources (not explicitly shown in FIG. 3) for comparing descriptor files, performing preprocessing of video, error checking, and communication with external entities, in addition to functionality provided by ad modifying engine 302.

In some embodiments of ad modification system 300, when snippet ad engine 152 has determined that snippet video 332 may be included in, or integrated with, original ad video 322 (based on the descriptor files discussed above), ad modifying engine 302 may proceed to modify original ad video 322 to generate snippet-modified ad 310. As noted above, ad modifying engine 302 may be provided preprocessed video and/or descriptor files, along with other signals, information and/or instructions by snippet ad engine 152. Ad modifying engine 302 may integrate snippet video 332 into original ad video 322, for example, using digital video editing techniques. In particular embodiments, ad modifying engine 302 may automatically perform digital video editing automatically and independently, based on parameters provided in descriptor files 324, 334. Ad modifying engine 302 may then output snippet-modified ad 310 to ad splicer/inserter 304, which may insert snippet-modified ad 310 into multimedia content stream 312 to generate multimedia content stream with snippet-modified ad 314. It is noted that in certain embodiments (not shown in FIG. 3), ad splicer/inserter 304 represents an external entity and is not explicitly included in ad modification system 300. Multimedia content stream with snippet-modified ad 314 may represent the MCDN program being viewed by client 120 that now includes snippet-modified ad 310.

In certain instances, the MCDN program may represent scheduled programming. It is noted that operation of ad modification system 300 may be performed in advance of delivery of multimedia content stream with snippet-modified ad 314, such that snippet-modified ad 310 and/or multimedia content stream with snippet-modified ad 314 are recorded for delivery to client 120 at a later time.

Turning now to FIG. 4, selected elements of an embodiment of a method 400 for ad modification are illustrated. In one embodiment, method 400 may be performed by ad modification system 300 (see FIG. 3) in conjunction with MCDN 100 (see FIG. 1, 2). It is noted that certain operations described in method 400 may be optional or may be rearranged in different embodiments.

Method 400 may begin by accessing (operation 402) an original ad video and an original ad descriptor file provided by an original ad provider. The original ad video may be provided in an analog or digital video format. When provided in an analog video format, the original ad video may be converted to a digital video format. Then, a snippet ad and a snippet ad descriptor file provided by a content provider may be accessed (operation 404). The snippet ad may be provided in an analog or digital format. When provided in an analog format, the snippet ad may be converted to a digital format. When provided as one or more images, the snippet ad may be converted to a video format. The accessing in operation 402 and/or operation 404 may involve receiving information, retrieving information, accessing information via a third-party source, and/or accessing information via a public network, such as Internet 172 (see FIG. 1). The original ad may be modified (operation 406) using digital video editing to incorporate the snippet ad according to the snippet ad descriptor file. The snippet ad may be modified prior to incorporation. The original ad descriptor file may further determine when and how operation 406 is performed. In certain instances, the original ad is not modified and the snippet ad is not used in operation 406. In other cases, the modification in operation 406 may generate a snippet-modified ad (see also FIG. 8). The snippet-modified ad may then be sent (operation 408) to an ad splicer/inserter. The snippet-modified ad may be inserted (operation 410) into a digital television stream by the ad splicer/inserter. It is noted that in certain embodiments, operation 410 may be omitted from method 400, for example, when the ad splicer/inserter is an external entity with respect to ad modification system 300 (see FIG. 3).

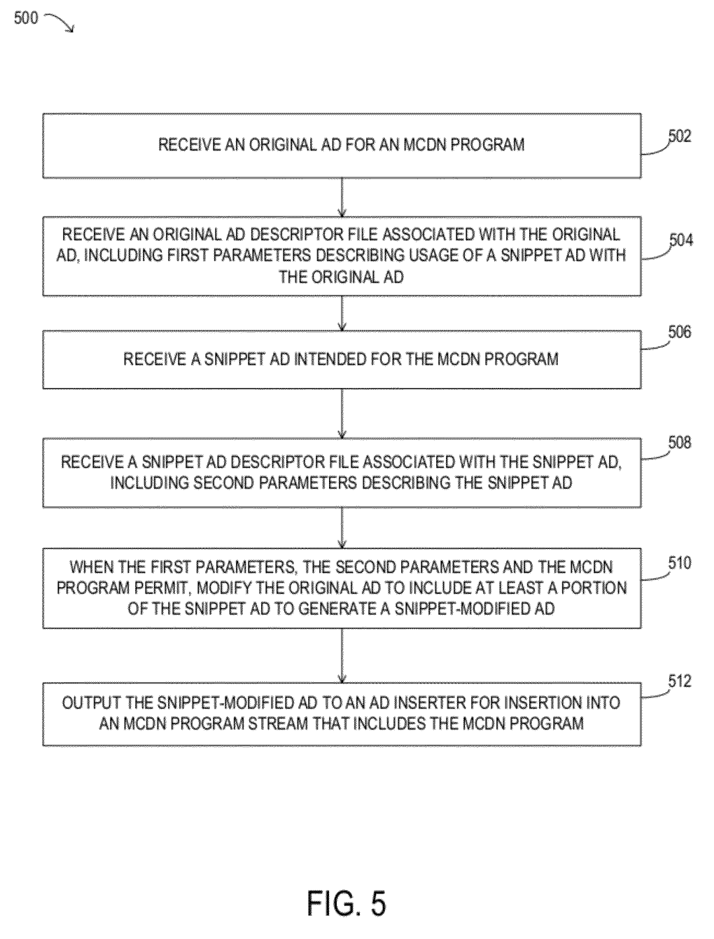

Turning now to FIG. 5, selected elements of an embodiment of a method 500 for ad modification are illustrated. In one embodiment, method 500 may be performed by ad modification system 300 (see FIG. 3) in conjunction with MCDN 100 (see FIG. 1, 2). It is noted that certain operations described in method 500 may be optional or may be rearranged in different embodiments.

In method 500, an original ad may be received (operation 502) for an MCDN program. The original ad may be received from an original ad provider for insertion into the MCDN program. An original ad descriptor file associated with the original ad may be received (operation 504) including first parameters describing usage of a snippet ad with the original ad. The original ad descriptor file may be received from the original ad provider. In certain instances, the original ad descriptor file may be received from another location or entity, such as a provider of a product appearing in the original ad, which may be a different entity than the original ad provider. A snippet ad intended for the MCDN program may be received (operation 506). The snippet ad may be received from a data stream providing the MCDN program, a data stream providing a different MCDN program, a network location, a third-party provider, by extraction from MCDN multimedia content, or a combination thereof. The snippet ad descriptor file associated with the snippet ad may be received (operation 508) including second parameters describing the snippet ad. When the first parameters, the second parameters, and the MCDN program permit, the original ad may be modified (operation 510) to include at least a portion of the snippet ad to generate a snippet-modified ad. The snippet-modified ad may be output (operation 512) to an ad inserter for insertion into an MCDN program stream that includes the MCDN program.

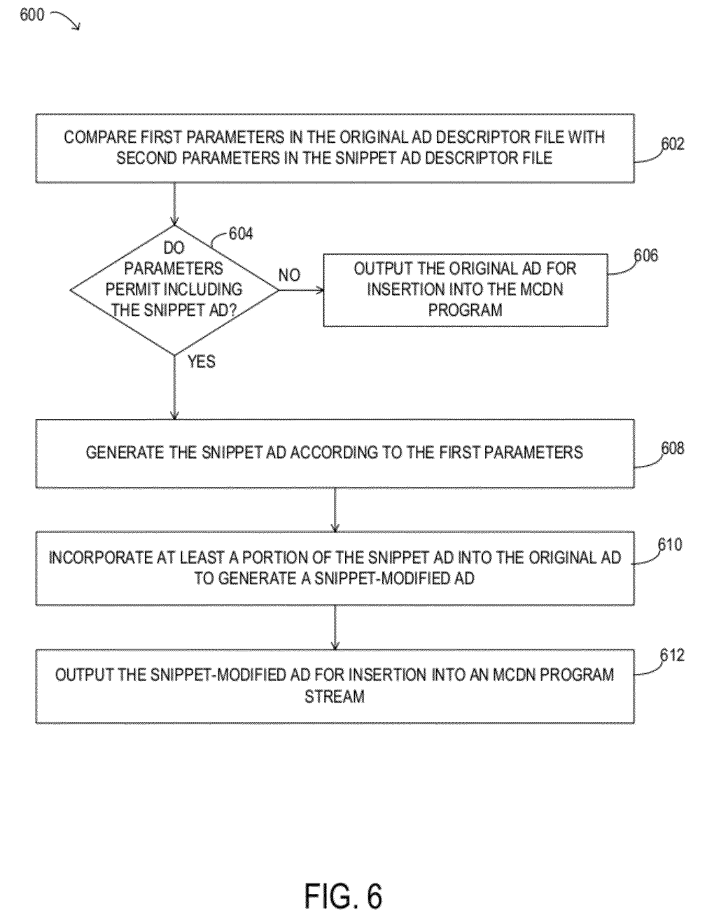

Turning now to FIG. 6, selected elements of an embodiment of a method 600 for ad modification are illustrated. In one embodiment, method 600 may be performed by ad modification system 300 (see FIG. 3) in conjunction with MCDN 100 (see FIG. 1, 2). In particular, method 600 may represent selected elements of an embodiment of operation 510 described above in method 500 (see FIG. 5). It is noted that certain operations described in method 600 may be optional or may be rearranged in different embodiments.

In method 600, parameters in the original ad descriptor file may be compared (operation 602) with parameters in the snippet ad descriptor file. For example, a content category parameter for the snippet ad in the original ad descriptor file may be compared to a content category restriction parameter in the snippet ad descriptor file. A decision may then be made (operation 604), whether the parameters permit including the snippet ad. When the result of operation 604 is NO, then the original ad (operation 606) is output for insertion into the MCDN program. When the result of operation 604 is YES, then the snippet ad may be generated (operation 608) according to the first parameters. Generation of the snippet ad in operation 608 may represent modification of received snippet image(s) or video, such as resizing or conversion to a desired format. At least a portion of the snippet ad may be incorporated (operation 610) into the original ad to generate a snippet-modified ad. The snippet-modified ad may be output (operation 612) for insertion into an MCDN program stream.

Referring now to FIG. 7, a block diagram illustrating selected elements of an embodiment of application server 150 for implementing ad modification system 300 (see FIG. 1, 3) is presented. In the embodiment depicted in FIG. 7, application server 150 includes processor 701 coupled via shared bus 702 to storage media collectively identified as memory media 710.

Application server 150, as depicted in FIG. 7, further includes network adapter 720 that interfaces application server 150 to a network (not shown in FIG. 7). In embodiments suitable for use in ad modification systems, application server 150, as depicted in FIG. 7, may include peripheral adapter 706, which provides connectivity for the use of input device 708 and output device 709. Input device 708 may represent a device for user input, such as a keyboard or a mouse, or even a video camera. Output device 709 may represent a device for providing signals or indications to a user, such as loudspeakers for generating audio signals.

Application server 150 is shown in FIG. 7 including display adapter 704 and further includes a display device or, more simply, a display 705. Display adapter 704 may interface shared bus 702, or another bus, with an output port for one or more displays, such as display 705. Display 705 may be implemented as a liquid crystal display screen, a computer monitor, a TV or the like. Display 705 may comply with a display standard for the corresponding type of display. Standards for computer monitors include analog standards such as VGA, XGA, etc., or digital standards such as DVI, HDMI, among others. A television display may comply with standards such as NTSC, PAL, or another suitable standard. Display 705 may include an output device 709, such as one or more integrated speakers to play audio content, or may include an input device 708, such as a microphone or video camera.

Memory media 710 encompasses persistent and volatile media, fixed and removable media, and magnetic and semiconductor media. Memory media 710 is operable to store instructions, data, or both. Memory media 710 as shown includes sets or sequences of instructions 724-2, namely, an operating system 712 and snippet ad engine 152. Operating system 712 may be a UNIX or UNIX-like operating system, a Windows® family operating system, or another suitable operating system. Instructions 724 may also reside, completely or at least partially, within processor 701 during execution thereof. It is further noted that processor 701 may be configured to receive instructions 724-1 from instructions 724-2 via shared bus 702. In some embodiments, memory media 710 is configured to store and provide executable instructions for executing snippet ad engine 152, as mentioned previously. For example, snippet ad engine 152 may be configured to execute method 400, 500 and/or 600. In certain embodiments, application server 150 may represent an implementation of ad modifying engine 302, in conjunction with MCDN 100 (see FIG. 1, 3). In various embodiments, network adapter 720 may be used as original ad provider 320 and/or content provider 330 (see FIG. 3).

Referring now to FIG. 8, selected elements on an embodiment of snippet-modified ad 800 are shown. Snippet-modified ad 800 depicts original ad video 802, which has been modified to incorporate snippet ad 810. In this example, original ad video 802 may be provided on behalf of service provider 121 for advertising features of MCDN 100 itself. As shown in the example of FIG. 8, snippet ad 810 includes previously received content from an MCDN program, which snippet-modified ad 800 interrupts, in this case, a sporting event (basketball). Since a viewer may be primarily interested in viewing events in the MCDN program, snippet ad 810 provides an uninterrupted glimpse of the program (the basketball game), which, in turn, may increase the likelihood that the viewer receives the message in original ad video 802 portion of snippet-modified ad 800. It is noted that snippet-modified ad 800 may include audio content associated with original ad video 802. It is further noted that while snippet ad 810 is shown in the exemplary embodiment of FIG. 8 as a reduced size ad in a top left corner of original ad video 802, it will be understood that, in other embodiments, snippet ad 810 may be of varying size in a different location, as desired. It is still further noted that snippet ad 810 may comprise multiple non-contiguous portions of original ad video 802.

In other embodiments of snippet-modified ads (not shown), other portions of content from the MCDN program may be used for snippet ad 810 portion of snippet-modified ad 800. For example, in the case of pre-recorded content, a preview of upcoming portions of the MCDN program may be included in snippet ad 810. In this manner, a regularly presented original ad video 802 may be imparted a sense of variety by dynamically changing the snippet ad 810 portion each time the original ad video 802 portion is presented. In another example, an advertiser presenting original ad video 802 portion may receive sponsorship from a content provider of the MCDN program for including the MCDN program in snippet ad 810 portion. In this manner, it may be possible for non-profit entities and/or other service, professional, military, civil, or community organizations to benefit from the use of snippet-modified ad 800. Although snippet ad 810 is shown in FIG. 8 in a reduced size in a corner of the screen area, in a further example, snippet ad 810 may occupy the entire screen area of snippet-modified ad 800, for example, by intermingling (not shown) for at least one period of time during a duration of original ad video 802. In a still further example, the content for snippet ad 810 may include renderings (i.e., computer-generated graphical content) of events, locations, characters, or other aspects of the MCDN program. In one embodiment, computer-generated avatars, or animated characters, may be used to interact dynamically with content in original ad video 802 portion. The avatars could represent real-life characters (i.e., performers, athletes, actors, etc.) or characters appearing in the MCDN program. In this manner, representations of celebrities may be used for endorsements without actually having to record a live advertising spot. In yet a further example, business or product information may be added by snippet ad 810 portion to original ad video 802 portion. The snippet ad may be an overlay that is textual or graphical content, and may include transparent portions that are irregularly shaped. For example, at the trailing portion of an automobile advertisement, a snippet ad showing contact information for a local dealer may be incorporated into (e.g., overlaid onto) original ad video 802. Such snippet ads may be used by service provider 121 (see FIG. 1) as promotions or ad samples for local small- and medium-sized businesses that might not otherwise be able to afford television advertising. In various embodiments, snippet ad 810 portion may be dynamic and be presented in any of a variety of forms and appearances, according to the methods disclosed herein.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for modifying an original ad delivered via digital television, the method comprising:
accessing an original ad descriptor file associated with the original ad, wherein the original ad descriptor file includes first parameters describing usage of a snippet ad with the original ad;
accessing a snippet ad descriptor file associated with the snippet ad, wherein the snippet ad descriptor file includes second parameters describing the snippet ad;
modifying the original ad by including at least a portion of the snippet ad to generate a snippet-modified ad; and
outputting the snippet-modified ad for insertion within a digital television program.

2. The method of claim 1, wherein the first parameters include at least one of: a display location of the snippet ad within the original ad; a display size of the snippet ad; a modification to the snippet ad; a desired duration of the snippet ad; and a content specifier for the snippet ad.

3. The method of claim 2, wherein the display size of the snippet ad corresponds to a full display size of the original ad.

4. The method of claim 1, wherein the second parameters include at least one of: an identifier for the snippet ad; a duration of the snippet ad; a format of the snippet ad; a content specifier for the snippet ad; and a usage description for the snippet ad.

5. The method of claim 1, further comprising:
when at least one of the first parameters and the second parameters prohibit modification of the original ad, outputting the original ad for insertion within the digital television program.

6. The method of claim 1, wherein the snippet ad includes at least one of: a video clip and a still image, and wherein the snippet ad includes an item of multimedia content selected from the list consisting of: a previously displayed portion of the digital television program; an upcoming portion of the digital television program; and a rendering of the digital television program.

7. The method of claim 1, wherein the snippet ad comprises at least one of: an ad including business information and an ad including product information.

8. A computing device for generating snippet-modified ads in a multimedia content distribution network (MCDN), the computing device comprising:
a processor coupled to memory media, wherein the memory media include processor executable instructions to:
access:
an original ad intended for an MCDN program;
an original ad descriptor file specifying usage of a snippet ad with the original ad;
the snippet ad; and
a snippet ad descriptor file specifying features of the snippet ad;
determine a snippet modification of the original ad based on the original ad descriptor file and the snippet ad descriptor file; and
perform the snippet modification of the original ad, wherein at least a portion of the snippet ad is incorporated into the original ad to create a snippet-modified ad.

9. The computing device of claim 8, wherein the memory media further include processor executable instructions to:
output the snippet-modified ad to an ad splicer for insertion into the MCDN program.

10. The computing device of claim 8, wherein the snippet ad comprises at least one of: a video clip and a still image, and wherein the processor executable instructions to perform the snippet modification further include processor executable instructions to:
modify the original ad using digital video editing to incorporate the snippet ad.

11. The computing device of claim 8, wherein the snippet-modified ad includes audio content associated with the original ad.

12. The computing device of claim 8, wherein the original ad descriptor file includes at least one of: a display location of the snippet ad within the original ad; a display size of the snippet ad; a modification to the snippet ad; a duration of the snippet ad; and content category restrictions for the snippet ad.

13. The computing device of claim 12, wherein the snippet ad descriptor file includes at least one of: an identifier for the snippet ad; a duration of the snippet ad; a format of the snippet ad; a content category for the snippet ad; and usage limitations for the snippet ad.

14. The computing device of claim 12, wherein said processor executable instructions to determine the snippet modification further include processor executable instructions to:
compare the content category for the snippet ad with the content category restrictions for the snippet ad.

15. Computer-readable memory media, including processor executable instructions for generating snippet-modified ads in a multimedia content distribution network (MCDN), said instructions executable to:
access an original ad intended for an MCDN program and an associated original ad descriptor file specifying usage of a snippet ad with the original ad;
access the snippet ad and an associated snippet ad descriptor file specifying features of the snippet ad;
compare the original ad descriptor file with the snippet ad descriptor file to determine a snippet modification of the original ad;
perform the snippet modification of the original ad, wherein at least a portion of the snippet ad is incorporated into the original ad to create a snippet-modified ad; and
insert the snippet-modified ad into the MCDN program.

16. The memory media of claim 15, wherein the original ad descriptor file includes at least one of: a display location of the snippet ad within the original ad; a display size of the snippet ad; a modification to the snippet ad; a desired duration of the snippet ad; and a desired content for the snippet ad.

17. The memory media of claim 15, wherein the snippet ad descriptor file includes at least one of: an identifier for the snippet ad; a duration of the snippet ad; a format of the snippet ad; content included in the snippet ad; and usage rules for the snippet ad.

18. The memory media of claim 17, wherein said instructions executable to perform the snippet modification further include instructions executable to:
generate the snippet ad based on at least one parameter included in the original ad descriptor file.

19. The memory media of claim 15, wherein the snippet ad comprises at least one of: a video clip and a still image, and wherein the snippet ad includes an item of multimedia content selected from the list consisting of: a previously displayed portion of the MCDN program; an upcoming portion of the MCDN program; a rendering of multimedia content appearing in the MCDN program; an ad including business information; and an ad including product information.

20. The memory media of claim 15, wherein the instructions executable to access the snippet ad further include instructions executable to receive the snippet ad from at least one of: a data stream providing the MCDN program; a data stream providing a different MCDN program; a network location; a third-party provider; and extraction from MCDN multimedia content.
